(19) United States
(12) Patent Application Publication
(10) Pub. No.: US 2021/0374701 A1
(43) Pub. Date: Dec. 2, 2021

(54) A METHOD FOR SECURED POINT OF SALES DEVICE

(71) Applicant: KARTEK KART VE BILISIM TEKNOLOJILERI TICARET ANONIM SIRKETI, Istanbul (TR)

(72) Inventors: Ahmet AKGÜN, Istanbul (TR); Hasan YASSIBAS, Istanbul (TR)

(21) Appl. No.: 17/059,731

(22) PCT Filed: Sep. 6, 2019
(86) PCT No.: PCT/TR2019/050729

§ 371 Date: Nov. 30, 2020

(30) Foreign Application Priority Data
Jan. 11, 2019 (TR) 2019/00444

(51) Int. Cl. G06Q 20/20; G06Q 20/36; G06Q 20/34; G06Q 20/32; G06Q 20/38

(52) U.S. Cl. CPC G06Q 20/20; G06Q 20/36; G06Q 20/3829; G06Q 20/3276; G06Q 20/352

(57) ABSTRACT

Disclosed is a method for software point of sales (POS) providing crypto keys, sensitive data and digital data safety by Trusted Execution Environment (TEE) provided on the software and device processor, run on an operating system (Android, iOS etc.) of any mobile device (mobile phone, tablet etc.) accepting payment by EMV based or special design QR, of contact free payment cards or contact free payment digital wallets (ApplePay, SamsungPay, AndroidPay, GooglePay or any special HCE based or other digital wallets).

### TECHNICAL FIELD

The invention relates to a method for software point of sales (POS) providing crypto keys, sensitive data and digital data safety by means of Trusted Execution Environment (TEE) provided on software and device processor, run on operating system (Android, iOS etc.) of any mobile devices (mobile phone, tablet etc.) accepting payment by EMV based or special design QR, of contact free payment cards or contact free payment digital wallets (ApplePay, SamsungPay, AndroidPay, GooglePay or any special HCE based or other digital wallets).

### PRESENT STATE OF THE ART

Payment devices used today are hardware devices operating as fully closed circuit. Therefore, required cryptographic keys are installed at a certain location by payment receiving organization before sending to member business enterprise. Since remote intervention is not allowed, when software failure occurs, in case of failure, field operation teams are needed for installation of payment receiving devices, updating software.

Abstract of application numbered TR2018/08160 seen during search of the related art discloses a method for providing security of transmission of payment date via open communication networks. The method comprises establishment of a data connection between a primary and secondary receiver-transmitter device, primary receiver—transmitter device is configured as a seller device and secondary receiver-transmitter device is configured as a customer receiver—transmitter device. Seller device transmits a primary data package comprising a unique seller identity and transaction request data to customer receiver-transmitter device through data connection. Seller device receives an encrypted text from customer receiver-transmitter device. Encrypted text is created by use of a secret key and counter value together with received unique seller identifier and access request data. The method comprises creation of a request for approval having received encrypted text, seller identifier and operation request data receiver and submission of said request for approval to regulatory authority or at least one of receivers for facilitating verification and process of said operation request data.

Another application encountered during technical search is the patent application numbered TR2017/01902 and the abstract of said application is “The invention relates to a system of payment and communication connections for remote servicing of customers. The system comprises a unit for generating a vendor appraisal, a single system server comprising the following interconnected units: a central control unit which is equipped with a rapid access button, an information storage unit, a unit for generating orders and commissions, a unit for forwarding a query, obtaining a reply from an independent information supplier and generating a notification, said unit containing a filter, a recommendation and advice unit, a unit for implementing orders and commissions, which can automatically suggest that a purchaser issue a paid letter of credit, and a unit for generating templates for future transactions, and purchaser computers which are connected to the single system server, are integrated by intra-system connection channels into a local information and payment network and interact with one another along wireless connection channels of the Internet, wherein the unit for generating a vendor rating constitutes a server of an independent information and vendor rating supplier, which is connected to the single server.”

The inventions whose abstracts are given do not have a novelty aiming at solution of above-mentioned negative issues.

As a result, due to above described disadvantages and inadequacy of existing solutions it has been necessary to make development in the related art.

Purpose of the Invention

The invention aims to disclose an embodiment with different technical characteristics which brings a new perspective in this field offering new solutions unlike the embodiments used in the present state of the art.

Primary purpose of the invention is to provide the security provided by hardware and closed circuit network in traditional POS devices by using of a trusted environment offered by software Whitebox cryptography and/or Trusted Execution Environment (TEE) of the relevant mobile operating system security provided by hardware and close circuit network at conventional POS devices.

A purpose of the invention is to disclose a method running on mobile operation system edited in mobile application format and meeting all functions set of conventional hardware POS devices.

The structural and characteristics features of the invention and all advantages will be understood better in detailed descriptions with the figures given below and with reference to the figures, and therefore, the assessment should be made taking into account the said figures and detailed explanations.

### BRIEF DESCRIPTION OF THE DRAWINGS

FIG. 1 is a general view of components providing realization of method disclosed under the invention.

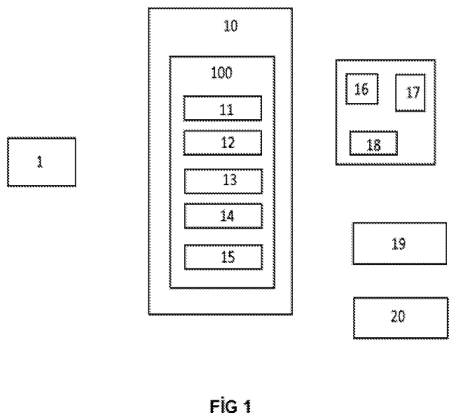

FIG. 2 is a flow diagram of method disclosed under the invention.

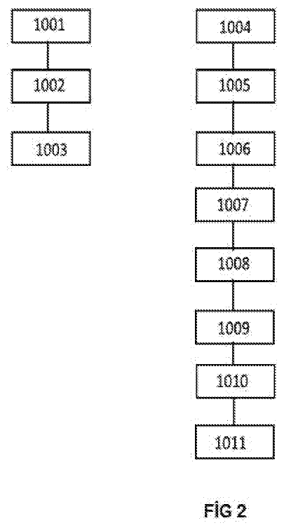

The drawings are not necessarily to be scaled and the details not necessary for understanding the present invention might have been neglected. In addition, the components which are equivalent to great extent at least or have equivalent functions at least have been assigned the same number.

### DESCRIPTION OF PART REFERENCES

1. Payment card (contactless card)
10. Mobile Device
100. Mobile application
11. POS unit (UI/UX)
12. SDK
13. Core unit (Kernel)
14. Crypto Administrator
15. NFC (Near Field Communication) antenna
16. Server application
17. Hardware security module (HSM)
18. Database
19. Payment receiving organization
20. Card holder organization

### DETAILED DESCRIPTION OF THE INVENTION

In this detailed description, the preferred embodiments of the invention have been described in a manner not forming any restrictive effect and only for purpose of better understanding of the matter.

Card holder organization (20) to make payment firstly makes application to payment receiving organization (19) and after completion of required procedure, it makes its registration in the system.

Card holder organization (20) must have mobile device (10) to use mobile application (100) disclosed under the invention. Card holder organization (20) downloads the mobile application (100) and installs it in mobile device (10). At this point the mobile application (100) is in the mobile device (10) without containing and information of member business enterprise.

For setup, user of the card holder organization (20) enters authentication data into pos unit (11) in mobile application (100). Identity details entered in Pos unit (11) are transmitted to Trusted Service Manager (TSM) of Point of sale device (POS) and after that to Payment Receiving Organization (19). After verification message is transmitted to pos unit (11) by Payment Receiving Organization (19) through same way, application configuration data and request of downloading keys is transmitted to TSM. TSM associates the key produced specifically for mobile device (10) and parameters with the device. Device single keys and Level 2, Level 3 layers and configuration parameters specific to POS are sent to the mobile device (10).

After safe connection to the server, mobile device (10) undergoes compliance and security controls and then security keys and required parameters are downloaded into the device. User selects from main screen the operation (sale, refund, cancel, etc.) to be executed. For instance, for sale transaction the amount is entered, and customer is asked to approach his-her card.

SDK (12) offers API for pos application and manages payment transactions by core unit (kernel) (13). Security of all application is provided by performing following controls;
Anti Root/Debug/Hook/Emulator
Source code comparison (obfuscation)
File reading, memory management etc. Use of system call functions written with assembly level for each processor architecture instead of standard android library functions.

Core applications of payment charts run in core unit (kernel) (13). Crypto administrator (14); is a library that provides security, key generation and cryptographic algorithm operation software provided by physical SAM (Secure Access Module) card in conventional payment receiver devices. With NFC (15) antenna following protocols are read by contactless cards; NFC-A, NDEF, NFC-F((JIS) X 6319-4), ISO/IEC 14443(NFC-A and NFC-B), NFCVE-V.

Process steps realized by the system disclosed under the invention are as follows:
applying to the system by downloading the mobile application (100) by card holder organization (20) (1001),
after registration of the card holder organization (20), generating required keys by server application (16) for protection of confidentiality and integrity of sensitive data (1002),
after downloading of keys to SDK (12), injecting them into Crypto Administrator (14) on software basis and recording device in connection with device-specific individual data (1003); (Therefore, use of recorded data in another device is prevented.)
entering payment amount from pos unit (11) screen by card holder organization (20) and starting of payment operation by transmitting of this data to SDK (12) (1004),
notifying to SDK (12) by detecting the payment card (1) by the NFC antenna (15) when approached to the mobile device (10) (1005),
starting of payment operation (EMV) by SDK with calling the core unit (13) (1006),
execution of contactless payment operation (EMV) by core unit (13) with submission of required commands to payment card (1) (1007),
transmitting of result of contactless payment operation to SDK (12) by core unit (13) (1008),
transmitting of sensitive data read from payment card (1) to server application (16) with Crypto Administrator (14) by protection of keys in form of Whitebox and Whitebox encrypting algorithm (1009); (at this point, since keys in form of Whitebox are kept by process ID of mobile application (100) at that time in device memory, keys do not run on any other devices or emulators.)
decryption of encrypted fields in server application (16) with the device key and encryption with payment receiving organization (19) keys in hardware security module (17) (1010),
transmitting of operation message to payment receiving organization (19) from server application (16) for authorization of payment transaction
   transmitting of authorization message to card holder organization (20) by payment receiving organization (19),
   returning of authorization result to payment receiving organization (19) by card holder organization (20) after necessary controls are done,
   transmitting of received result of authorization to serve application (16) by payment receiving organization (19)
   returning of transaction result to SDK (12) by server application (16) after registration of process data into database (18), (1011),
transmission of transaction result to pos unit (11) by SDK (12) and displaying of message related to transaction result (successful/unsuccessful) to user by pos unit (11) (1012).

1. A method for a software payment receiver device/POS wherein security of crypto keys, sensitive data and digital wallet run on operating system running on a mobile device accepting payment by contactless payment cards or contactless digital wallets or EMV based or special design QR, characterised by comprising process steps of:
applying to the system by downloading a mobile application by a card holder organization;
after registration of the card holder organization, generating required keys by a server application for protection of confidentiality and integrity of sensitive data, after downloading of keys to an SDK, injecting them into a Crypto Administrator on software basis and recording device in connection with device-specific individual data;
notifying to SDK by detecting the payment card by an NFC antenna when approached to the mobile device;
starting of payment operation (EMV) by SDK with calling a core unit;
execution of contactless payment operation (EMV) by the core unit with submission of required commands to the payment card;
transmitting of result of contactless payment operation to SDK by the core unit;
transmitting of sensitive data read from the payment card to the server application with the Crypto Administrator by protection of keys in the form of Whitebox and Whitebox encrypting algorithm;
transmitting of operation message to a payment receiving organization from the server application for authorization of the payment transaction;
transmitting of an authorization message to the card holder organization by the payment receiving organization;
returning of an authorization result to the payment receiving organization by the card holder organization after necessary controls are done;
transmitting of the received result of authorization to the server application by the payment receiving organization;
returning of the transaction result to SDK by the server application after registration of process data into a database;
transmitting of the transaction result to pos unit by SDK and displaying of a message related to transaction result (successful/unsuccessful) to the user by the pos unit.

2. A method according to claim 1, characterised by comprising the process step of entering payment amount from the pos unit screen by the card holder organization and starting of payment operation by transmitting of this data to SDK after the process step of generating required keys by a server application.

3. A method according to claim 1, characterized by comprising the process step of decryption of encrypted fields in the server application with the device key and encryption with payment receiving organization keys in a hardware security module after process step of transmitting of sensitive data read from the payment card to the server application.
